(19) United States
(12) Patent Application Publication
(10) Pub. No.: US 2017/0321463 A1
(43) Pub. Date: Nov. 9, 2017

(54) VEHICLE DOOR HINGE AND METHOD FOR MANUFACTURING SAME

(71) Applicant: Mitsui Kinzoku Act Corporation, Yokohama-shi, Kanagawa (JP)

(72) Inventor: Hiroshi Morinaga, Yokohama (JP)

(73) Assignee: Mitsui Kinzoku Act Corporation, Yokohama-shi, Kanagawa (JP)

(21) Appl. No.: 15/525,229

(22) PCT Filed: Nov. 6, 2015
(86) PCT No.: PCT/JP2015/081350

§ 371 Date: May 8, 2017

(30) Foreign Application Priority Data
Nov. 27, 2014 (JP) 2014-239959

(51) Int. Cl. E05D 11/06; E05D 5/06; E05D 3/02; B21D 53/40; B60J 5/04

(52) U.S. Cl. CPC E05D 11/06; E05D 3/02; B21D 53/40; E05D 5/062; B60J 5/04; E05Y 2900/531

(57) ABSTRACT

A vehicle door includes a fixed bracket having a base plate part fixed by a bolt to an attachment surface of a vehicle body, and a pair of bent pieces bent at a right angle in relation to the base plate part and set apart from each other in the axial direction of a hinge shaft. In the bent pieces are formed: a shaft hole in which the hinge shaft is inserted; and a raised stopper part projecting from the inner-side surface of the bent piece, the raised stopper part coming into contact with a stopped part of a movable bracket, whereby the movable bracket is stopped in the fully open position.

### CROSS REFERENCE TO RELATED APPLICATIONS

This is the U.S. National Stage of International Application No. PCT/JP2015/081350, filed Nov. 6, 2015, which in turn claims the benefit of and priority to Japanese Patent Application No. JP2014-239959, filed Nov. 27, 2014.

### TECHNICAL FIELD

The present invention relates to a vehicle door hinge for mounting a door to a vehicle pivotally, and a method for manufacturing the same.

### BACKGROUND

A conventional door hinge for a vehicle comprises, as described in JP2014-152455A, a fixed bracket (a first bracket in the Patent document 1) pressingly molded of a steel plate and fixed to a vehicle body with a bolt, a moving bracket (similarly, a second bracket) pressingly molded of a steel plate and fixed to a door with a bolt, and a hinge shaft relatively pivotally connecting both brackets.

The fixed bracket comprises a base portion having a bolt hole in which the bolt is disposed, a pair of bent portions (an arm plate portions in the Patent document 1) formed at upper and lower edges of the base portion by bending and in which the hinge shaft is disposed, and a pair of rib portions standing up from the upper and lower edges of the base portion so as to extend from the bent portions to the other side portion of the base portion and to oppose each other across the bolt hole.

The fixed bracket is manufactured by press working in the following processes. First, a bracket substrate is pierced from a starting steel plate using a press machine, where the bracket substrate has corresponding portions each of which corresponds to the base portion, both of bent portions and both of ribs respectively. At the same time, the bolt hole is formed in the portion corresponding to the base portion, and, in the portion corresponding to each of the pair of bent portions, a pin hole wherein the hinge shaft is disposed and a stopper projection are formed.

The stopper projection is provided for restricting the amount of rotation of the moving bracket and stopping the door at a full open position, and it is formed into a semilunar upheaval formation on an internal surface by extrusion molding from an outer side surface side.

Subsequently, the bracket substrate is bent with a press machine into right-angle along boundary lines of the base portion, the bent portions, and the rib portions, manufacturing a partially-finished bracket product.

### SUMMARY

However, since the stopper projection of the door hinge disclosed in JP2014-152455A is formed around approximately center part of each of the bent portions in the fixed bracket by extrusion molding, and is formed a half-moon-shape in comparatively small size, therefore, when the moving bracket hits the stopper projection in a fully-open position of the moving bracket and excessive shear stress acts on the stopper projection, there is a possibility that the stopper projection may deform.

Furthermore, according to the manufacturing process of the fixed bracket, after forming a shaft hole and a stopper projection at the portion corresponding to both bent portions of the bracket substrate of the flat plate pierced from the starting steel plate, the bracket substrate is bent right angle by presswork at the portion corresponding to both bent portions of the bracket substrate. Therefore, it has a problem of being hard to secure high accuracy of positions of the shaft hole and the stopper projection because of influence of spring back occurred at the bent region of the both bent portions.

In view of the above-mentioned problem, an object of the present invention is to provide a vehicle door hinge in which the intensity of a raised stopper part is improved, and to provide a method for manufacturing the vehicle door hinge in which the accuracy of positions of the shaft hole and the raised stopper part is improved.

In order to solve the aforementioned problem, according to a first aspect of the present invention, there is provided a vehicle door hinge comprising: a moving bracket fixed to a mounting surface of a door; a fixed bracket fixed to a mounting surface of a vehicle body; and a hinge shaft relatively pivotably linking the moving bracket and the fixed bracket, wherein the fixed bracket comprises a base portion fixed to the mounting surface of the vehicle body with a bolt, and a pair of bent portions bent at right angles from the base portion and spaced from each other in axial direction of the hinge shaft, wherein each of the pair of bent portions comprises a shaft hole in which the hinge shaft is disposed, and a raised stopper part projecting from the inner-side surface of the bent portion, for stopping the moving bracket at the full open position of the door when the raised stopper part hits a stopped part of the moving bracket, wherein, when the moving bracket is in a fully open position, the raised stopper part is extended linearly from an end face of the bent portion that faces the mounting surface of the door toward the stopped part of the moving bracket, and the extend end of the raised stopper part provides a stopper surface where the stopped part is abutted.

According to a second aspect of the present invention, there is provided a method for manufacturing a vehicle door hinge, wherein the vehicle door hinge comprises, a moving bracket fixed to a mounting surface of a door; a fixed bracket fixed to a mounting surface of a vehicle body; and a hinge shaft relatively pivotably linking the moving bracket and the fixed bracket, wherein the fixed bracket comprises a base portion fixed to the mounting surface of the vehicle body with a bolt, and a pair of bent portions bent at right angles from the base portion and spaced from each other in axial direction of the hinge shaft, wherein each of the pair of bent portions comprises a shaft hole in which the hinge shaft is disposed, and a raised stopper part projecting from the inner-side surface of the bent portion, for stopping the moving bracket at the full open position of the door when the raised stopper part hits a stopped part of the moving bracket, wherein a process for manufacturing the fixed bracket by processing a metal plate material comprises steps of, a first step for bending the bent portions at right-angles to the base portion by press molding, a second step for making each of the shaft holes to the bent portions which are bent, and a third step for projecting and forming each of the raised stopper parts to the bent portions which are bent.

According to the vehicle door hinge of the first aspect of the present invention, since the raised stopper part is extended from the end face of the fixed bracket toward the stopped part of the moving bracket, and it has the stopper surface at the extend end where the stopped part abut, strength of the raised stopper part can be improved.

According to the method for manufacturing the vehicle door hinge of the second aspect of the present invention, since the shaft hole and the raised stopper part are formed in the bent portion after carrying out bending processing of the bent portion, influence of the spring back can be made minimum, and the accuracy of position of a shaft hole and a raised stopper part can be improved.

### BRIEF DESCRIPTION OF THE DRAWINGS

FIG. 1 is a side view of a vehicle equipped with a door hinge according to the present invention.

FIG. 2 is a perspective view of a lower door hinge according to the present invention.

FIG. 3 is a perspective view of an upper door hinge according to the present invention.

FIG. 4 is a side view of the upper door hinge shown in FIG. 3.

FIG. 5 is a view seen in a direction of an arrow V in FIG. 4.

FIG. 6 is a view seen in a direction of an arrow VI in FIG. 4.

FIG. 7 is a view seen in a direction of an arrow VII in FIG. 4.

FIG. 8 is a view seen in a direction of an arrow VIII in FIG. 7.

FIG. 9 is a cross sectional view along line IX-IX in FIG. 5.

FIG. 10 is a cross sectional view along line X-X in FIG. 4.

FIG. 11 is a cross sectional view of the same part as the FIG. 10 when the door is fully opened.

FIG. 12 is a cross sectional view of the same part as the FIG. 10 when the door hinge is deformed.

FIG. 13 is an expanded cross sectional view along line XIII-XIII in FIG. 11.

FIG. 14 is a development view of a fixed bracket in the lower door hinge.

FIG. 15 is a schematic view for showing a manufacturing process of the fixed bracket.

### DESCRIPTION OF THE EMBODIMENTS

Hereinafter, the best embodiment of the present invention is described by reference to drawings.

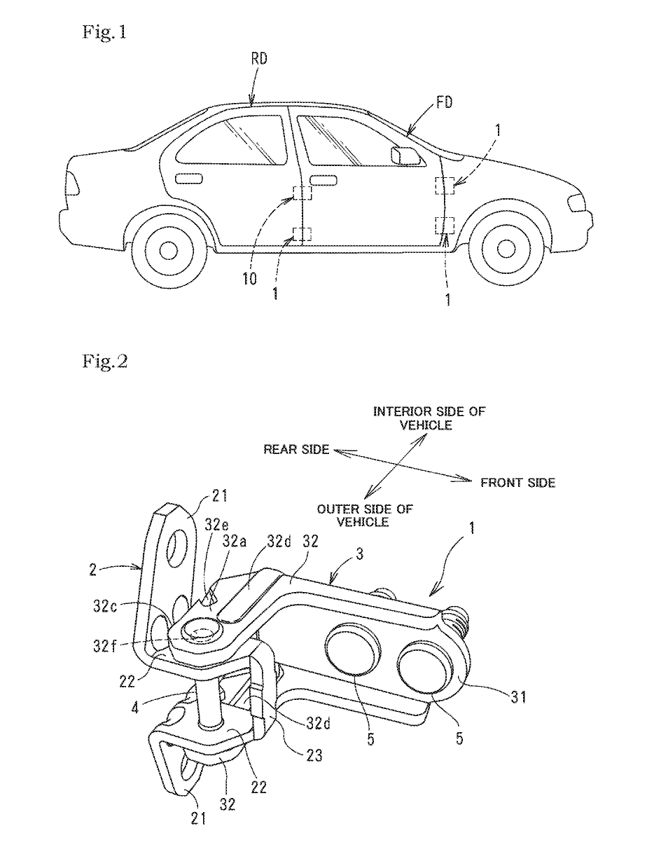

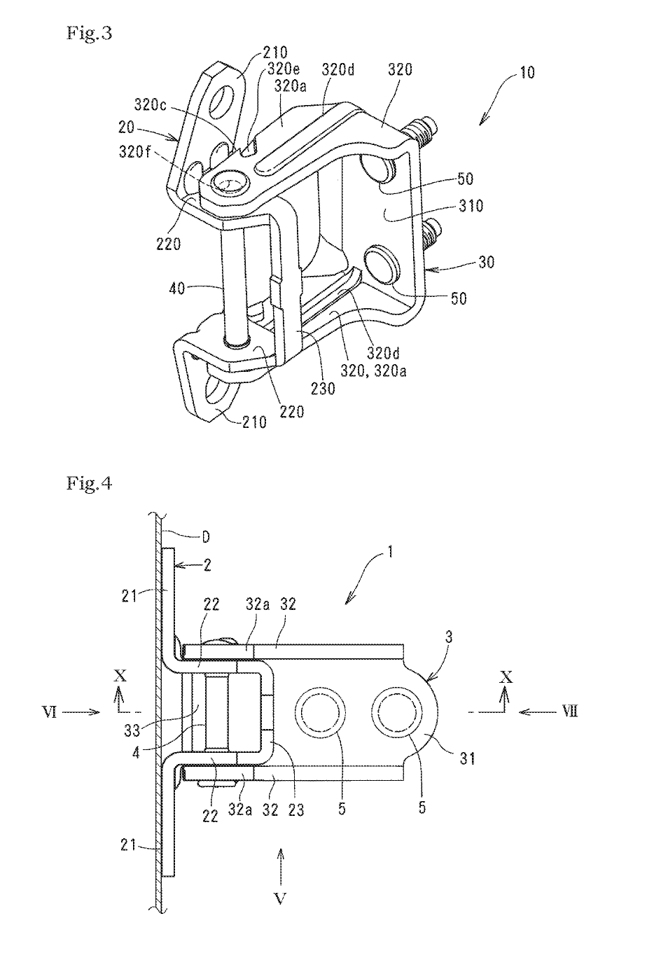

As shown in FIG. 1, a rear door RD is pivotally mounted on a vehicle body side surface with a lower door hinge 1 shown in FIG. 2 and an upper door hinge 10 shown in FIG. 3. Regarding to a front door FD, the lower door hinge 1 shown in FIG. 2 is used for upper side and lower side, and the front door FD is pivotally mounted on the vehicle body side surface.

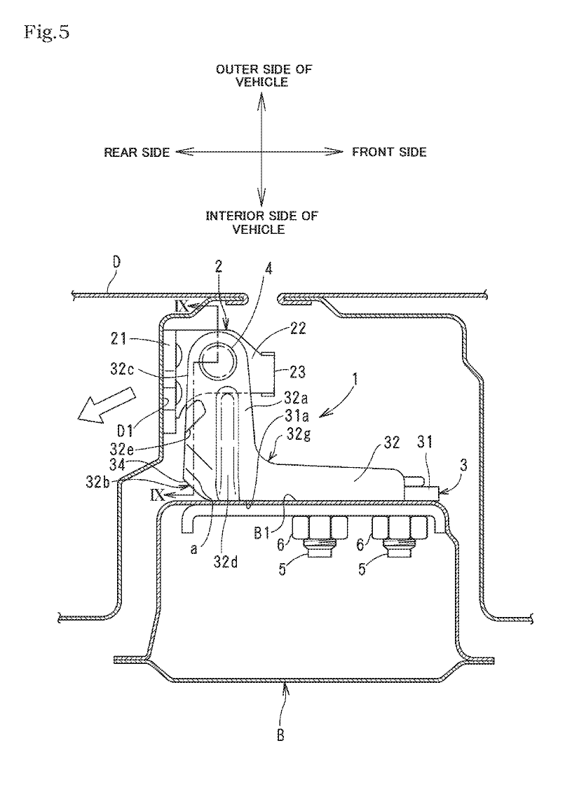

As shown in FIG. 2, the lower door hinge 1 comprises a moving bracket 2 fixed to a lower part at the front-end face of the rear door (hereinafter referred to as “door”) RD, a fixed bracket 3 fixed to a pillar B which forms a part of the vehicle body (refer to FIG. 5, for example) with two bolts 5 at the front side and rear side, and a cylindrical hinge shaft 4 extending upper and lower direction with a brim for pivotally connecting the moving bracket 2 and the fixed bracket 3.

As shown in FIG. 3, the upper door hinge 10 comprises a moving bracket 20 fixed to an upper part at the front end of the door RD, a fixed bracket 30 fixed to the pillar B with two bolts 50 at upper side and lower side, and a cylindrical hinge shaft 40 extending upper and lower direction with a brim for pivotally connecting the moving bracket 20 and the fixed bracket 30.

With respect to the lower door hinge 1 and the upper door hinge 10, although they are different in shape, since function and manufacturing process of each part of them are the same, in the following descriptions, only the lower door hinge 1 is described. About the upper door hinge 10, the reference letter “0” is given to the end of each reference letter given to each element which has the same function as the lower door hinge 1, and detailed description is omitted.

The moving bracket 2 of the lower door hinge (hereinafter referred to as “a door hinge”) 1 is pressingly molded of a steel plate, and integrally molded with a pair of upper and lower fixing portions 21, 21 fixed to a mounting surface D1 (refer to FIG. 5) or front end face of the door RD, a pair of upper and lower bent portions 22, 22 bent forward at right angles from each of the fixing portions 21, 21 and perpendicular to the hinge shaft 4, and a connecting portion 23, in parallel with the hinge shaft 4, for connecting the bent portions 22, 22. In each of the bent portions 22, 22, a shaft hole 22b (refer to FIG. 9) in which the hinge shaft 4 is disposed is formed, and a bush 7 with a flange (refer to FIG. 9) is fitted.

The fixed bracket 3 is pressingly molded of a steel plate, and is integrally molded with a base portion 31 fixed to the mounting surface B1 facing the vehicle outside of the pillar B with two bolts 5 and two nuts 6 in front and in the rear, a pair of bent portions 32, 32 which are bent to the outside of the vehicle at right angles to the base portion 31 at the upper and lower portions of the base portion 31 and are spaced from each other in axial direction of the hinge shaft 4, and a connecting portion 33 tilted at a predetermined angle to the base portion 31 in the rear portion of the base portion 31. The connecting portion 33 is formed in parallel with the hinge shaft 4 so that a corner 32b and its neighborhoods of both bent portions 32 may be connected.

Each of the bent portions 32 has the corner 32b close to the mounting surface B1 of the pillar B, and an internal corner 32g of L-shaped when seen axially of the hinge shaft 4, in the side which faces to the outside of the vehicle, and is like an L-shape (refer to FIG. 5, for example), and a pivot portion 32a, pivotally connected to the moving bracket 2, is formed in the area largely extending toward outside rather than other area.

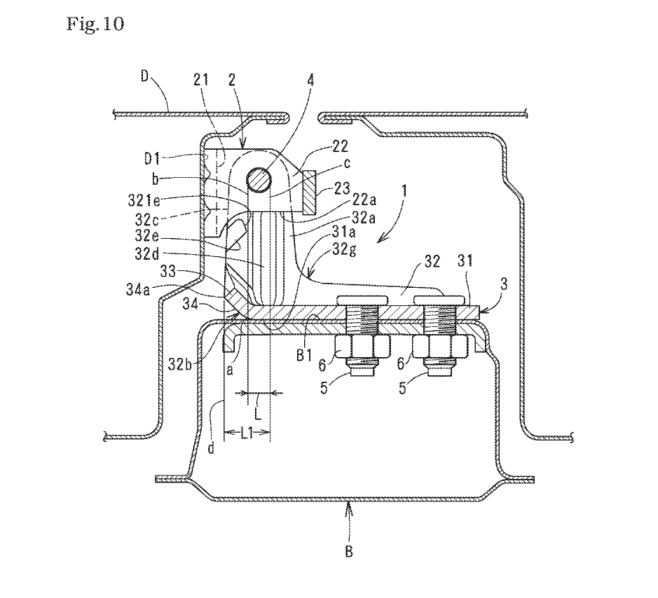

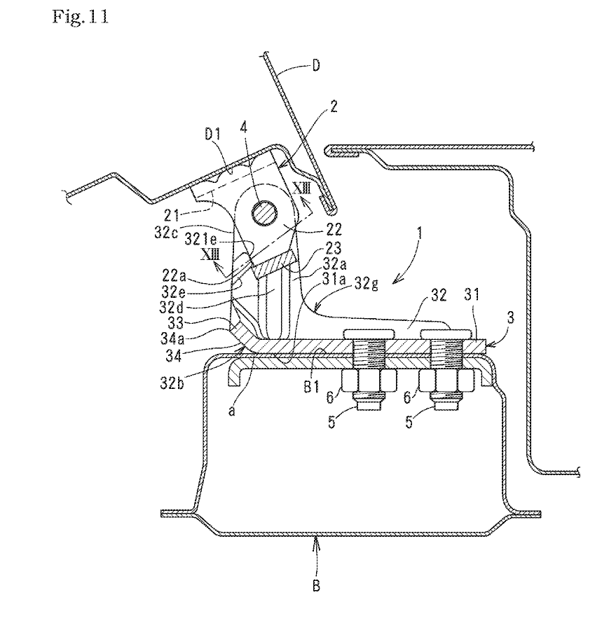

As shown in FIGS. 5 and 10, on the axial directional vision of the hinge shaft 4, an end face 32c, a backward end face (an end face facing to the mounting surface D1 of the door RD when the door D is closed in FIG. 5) of the pivot portion 32a in each bent portion 32, is formed at right angles or approximately right angles with respect to the mounting surface B1 of the pillar B (87 degrees in this embodiment).

In order to improve rigidity of the bent portions 32 in the direction of the board thickness, there is provided a projection 32d which extends straight from the portion where containing intersection of both bent portions 32 and the base portion 31 towards the outside of the vehicle, on the upper surface of the upper bent portion 32 and on the lower surface of the lower bent portion 32. Further, in the pivot portion 32a of each bent portion 32, there is provided a raised stopper part 32e for restricting the full open position of the door RD and a shaft hole 32f (refer to FIG. 9) in which the hinge shaft 4 is disposed are formed.

As shown in FIG. 9, the hinge shaft 4 pivotally connects the moving bracket 2 and the fixed bracket 3, by inserting the hinge shaft 4 into the bush 7 fitted to the shaft hole 22b of the moving bracket 2 and into the shaft hole 32f of the fixed bracket 3, in the state where both bent portions 22 of the moving bracket 2 are located between both bent portions 32 of the fixed bracket 3. In addition, an end 4b, which is located in the opposite side to a brim 4a of the hinge shaft 4 and projected from the shaft hole 32f of the fixed bracket 3, is caulked.

The raised stopper part 32e provided in each bent portion 32 of the door hinge 1 projects from an internal surface (from a lower surface at the upper pivot portion 32a, from an upper surface at the lower pivot portion 32a) to an inner side (to a bottom side at the upper pivot portion 32a, to an upper side at the lower pivot portion 32a), and the raised stopper part 32e is extended linearly from each end face 32c of each bent portion 32 to the stopped part 22a of the moving bracket 2, when the moving bracket 2 is in the state of a full open position, as shown in FIG. 11. At the extended end where facing to the direction to be extended, a flat stopper surface 321e to which the stopped part 22a is abutted is formed.

As shown in FIG. 11, when the door RD rotates in a full open position, the door RD can be stopped in the full open position by the stopped part 22a, provided to the end face of each bent portion 22 in the moving bracket 2, hitting the stopper surface 321e of the raised stopper part 32e of the fixed bracket 3.

As mentioned above, since the raised stopper parts 32e can be made into bigger shape as compared with a prior art, by extending the raised stopper parts 32e from each end face 32c to the stopped parts 22a of the moving bracket 2 and making the extend ends as the stopper surfaces 321e, the strengthen of the raised stopper parts 32e can be improved and the accuracy of the position for restricting the full open position of the door RD can be raised.

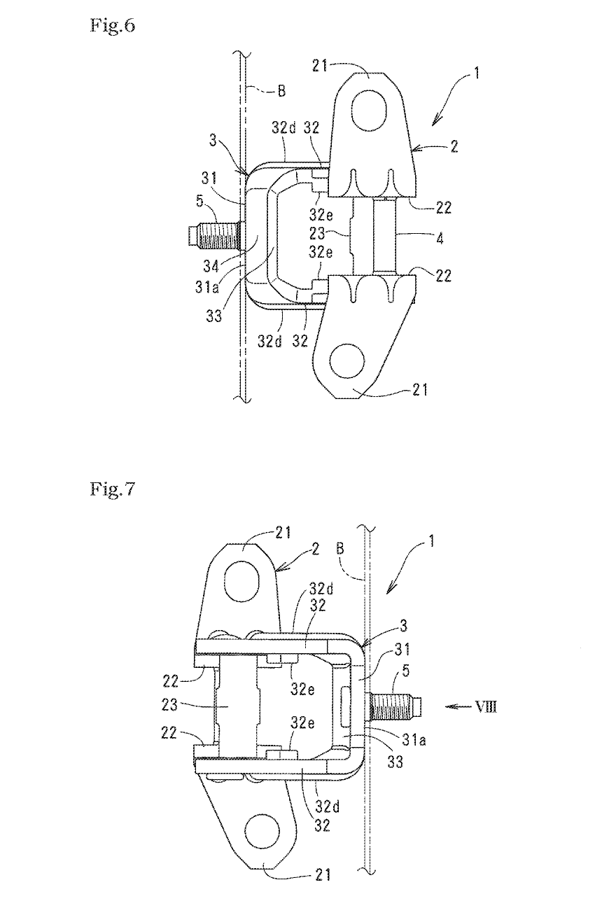

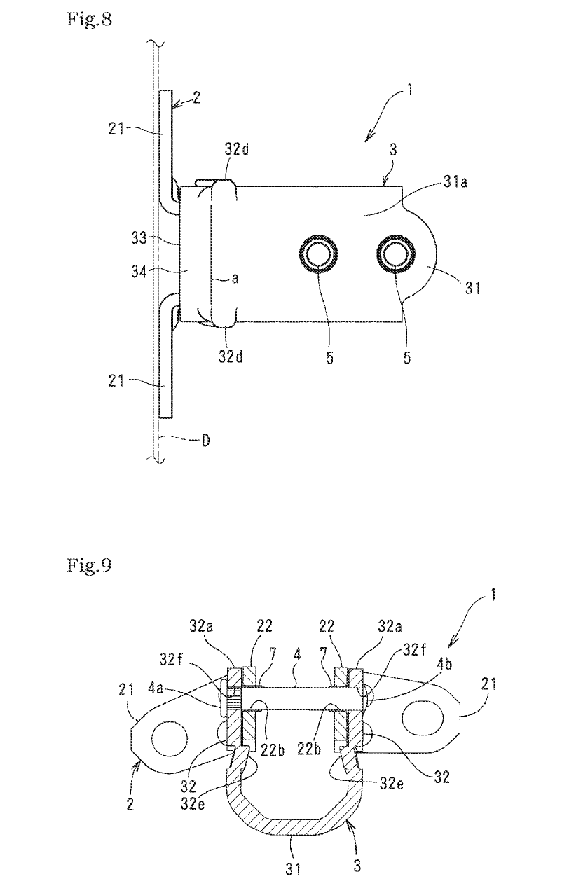

As shown in FIGS. 6 and 8, for example, the connecting portion 33 of the fixed bracket 3 is formed at the back part of the base portion 31 and connects the upper bent portion 32 to the lower bent portion 32 at a corner 32b and its vicinity, thereby improving bending strength along thickness direction (vertical direction) of the bent portions 32.

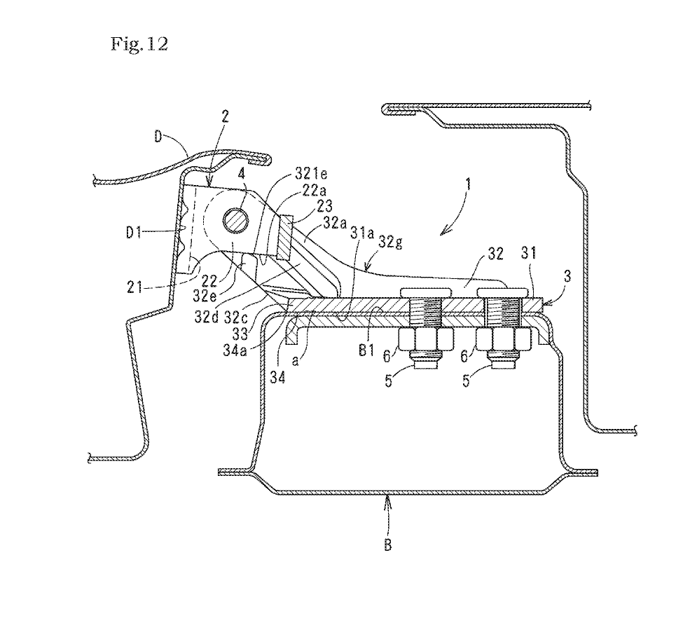

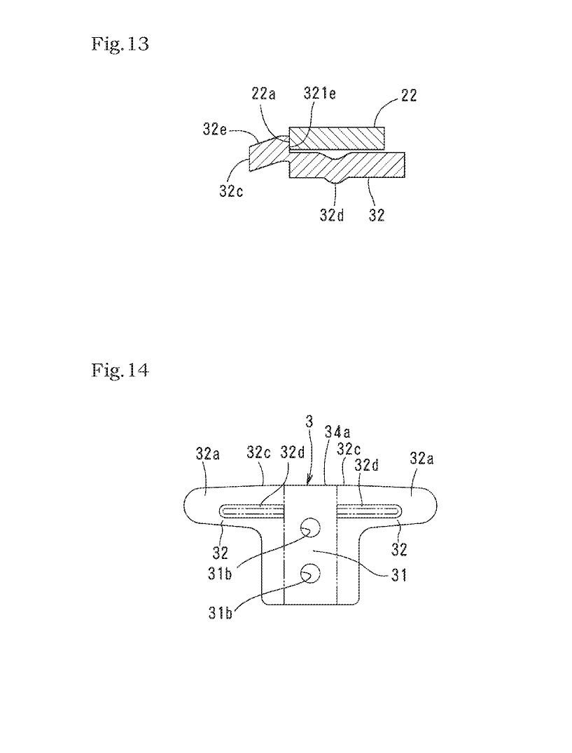

As shown in FIG. 10, for example, a deformation-promoting portion 34 in the connecting portion 33 is a slope facing to the mounting surface B1 of the pillar B at a predetermined angle (about 40 degrees in this embodiment) and is not normally in contact with the mounting surface B1 of the pillar B. As shown in FIG. 12, the deformation-promoting portion 34 is formed such that when the bent portions 32 are deformed to enlarge the angle of the L-shaped internal corner 32g, it contacts the mounting surface B1.

Further, as shown in FIG. 10, the deformation-promoting portion 34 is formed such that an intersection “a” at which contact with a vehicle-body contact surface (a surface contacts with the mounting surface B1) 31a of the vehicle-body fixed portion 31 is positioned within a hinge-shaft diameter region L, and the deformation-promoting portion 34 is tilted from the intersection “a” so as to be apart it gradually from the mounting surface B1 of the pillar B toward back side (in FIG. 10, left side). Furthermore, a rear end 34a of the deformation-promoting portion 34 agrees with the end face 32c of the pivot portion 32a of each of the bent portions 32 of the fixed bracket 3, so that the rear end does not project backward from the facing side 32c.

The hinge shaft diameter region L is defined such as, when seen axially of the hinge shaft 4 as shown in FIG. 10, among tangents which contact an outer circumference of the hinge shaft 4, the two tangential lines “b” and “c” which are right-angle to the mounting surface B1, and when extending them to the mounting surface B1, a region between both extended tangential lines “b” and “c” is the hinge shaft diameter region.

Now, deformation of the fixed bracket 3 is explained in detail. As shown in FIGS. 5 and 10, the deformation-promoting portion 34 is normally non-contact state with the mounting surface B1. When the door RD is deformed toward the inside of the vehicle owing to side impact on the door RD, the moving hinge member 2 is pulled in obliquely backward (in a white arrow direction in FIG. 5), since the deformation-promoting portion 34 is not in contact with the mounting surface B1 of the pillar B before the deformation, the bent portion 32 is deformed such that the angle at the L-shaped internal corner 32g is enlarged at the intersection “a” as a fulcrum between the deformation-promoting portion 34 and the vehicle-body contacting surface 31a. In this case, since the intersection “a” is positioned within the hinge-shaft diameter region L, and the bent portion 32 cannot easily be deformed, but when each bent portion 32 of bending deforms to some extent, the deformation-promoting portion 34 becomes into contact with the mounting surface B1, as shown in FIG. 12 and straddles in this state, thus, the bent portion 32 is prevented from being further deformed. It is prevented that the base portion 31 of the fixed bracket 3 may get turned up from the mounting surface B1, or prevented the internal corner 32g from being ruptured suddenly owing to stress concentration on the internal corner 32g, thereby improving strength of the door hinge 1 and enabling the door RD to be supported more firmly.

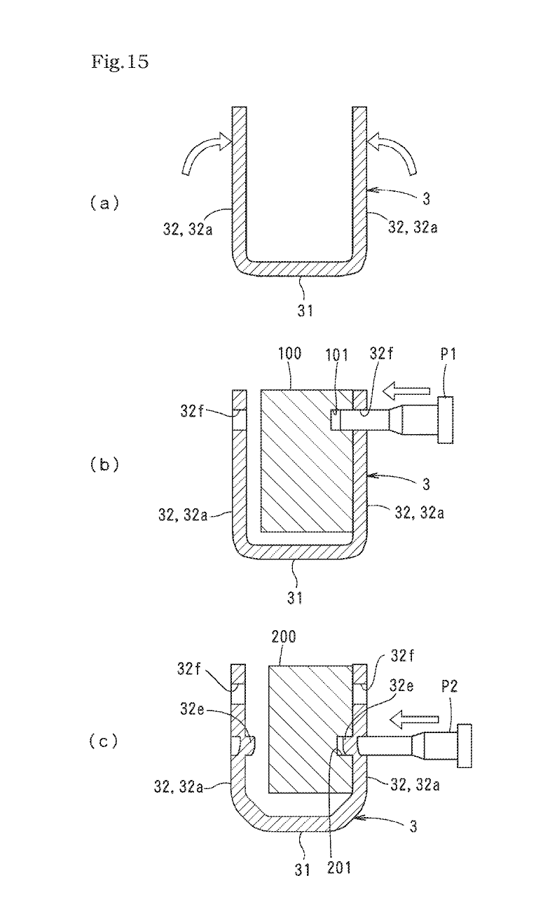

Next, a manufacturing method of the fixed bracket 3 is explained by reference to FIGS. 14 and 15. First, as shown in FIG. 14, the approximately T-shaped fixed bracket 3 is pierced in an expanded state from a metal plate material by press forming. At this process, the two bolt insertion holes 31b where the bolts 5 are disposed are formed in the portion equivalent to the base portion 31, and the projections 32d are projected and molded into the portion equivalent to each bent portion 32.

Regarding fixed bracket 3, as mentioned above, on the axial directional vision of the hinge shaft 4, each end face 32c of each bent portion 32 is formed at right angles or approximately right angles with respect to the mounting surface B1 of the pillar B, and the rear end 34a of the connecting portion 33 agrees with the end face 32c of each bent portion 32. Thus, the development view of the fixed bracket 3 becomes T-shaped, as shown in FIG. 14, where the pivot portion 32a of each of the bent portion 32 extends substantially straightly to the longitudinal direction of the hoop of the metal plate material (a horizontal direction in FIG. 14), and the base portion 31 extends substantially right-angled from a center portion of each pivot portion 32a to the width direction of the hoop (a vertical direction in FIG. 14). Thereby, the yield of the fixed bracket 3 by press forming is improved and enabling to plan cost reduction.

Then, at the process shown in FIG. 15 (a), both of bent portions 32 are formed by bending both side parts of the T-shaped fixed bracket 3 in the expanded state by presswork.

Then, at the process shown in FIG. 15 (b), the shaft hole 32f is made by shearing force in the bent portions 32, by side pierced molding of the press molding, in the state where the die 100 is set among both the bent portions 32, moving the punch P1 to the arrow direction from the outer side surface side of one of the bent portions 32 among both the bent portions 32, and driving the punch into the concave portion 101 of the die 100. Then, another shaft hole 32f is also made to another side of the bent portions 32 by the same method.

Then, at the process shown in FIG. 15 (c), the raised stopper part 32e projecting towards inner side is made by shearing force in the bent portion 32, by side pierced molding of the press molding, where the die 200 is set among both the bent portions 32, and moving the punch P2 to the arrow direction from the outer side surface side of one of the bent portion 32 among both the bent portions 32, and drive the punch into the concave portion 201 of the die 200. Then, another raised stopper part 32e is also made to the other one of the bent portions 32 by the same method.

As mentioned above, by molding the raised stopper part 32e and the shaft hole 32f into each bent portion 32, after molding both the bent portions 32 by folding by press forming, the influence of the spring back to the both bent portions 32 formed by bending processing can be minimized, and the accuracy of position of the raised stopper part 32e and the shaft hole 32f can be improved.

Regarding the raised stopper part 32e, molding of the raised stopper part 32e can be made easy and strength improvement can be planned, by having the form which extends from the end face 32c of each bent portion 32 towards the stopper portion 22a where the moving bracket 2 is in a full open position, and makes the end of the direction to extend as the stopper surface 321e, by side pierced molding of the press molding.

The foregoing description relates to the embodiments of the present invention. Various changes and deformations may be made within the scope which does not deviate from the summary of the present invention.

For example, in the side pierced molding process of press molding in the method for manufacturing the fixed bracket 3,

Making each shaft hole 32f after projecting and forming each raised stopper part 32e.

Simultaneously projects and forms the raised stopper part 32e in both of bent portions 32, respectively.

Simultaneously projecting and forming each shaft holes 32f in both of bent portions 32, respectively.

Simultaneously forming each raised stopper part 32e and each shaft hole 32f, in the bent portions 32.

1. A vehicle door hinge comprising:
a moving bracket fixed to a mounting surface of a door;
a fixed bracket fixed to a mounting surface of a vehicle body; and
a hinge shaft pivotably linking the moving bracket and the fixed bracket,
wherein the fixed bracket comprises a base portion fixed to the mounting surface of the vehicle body with a bolt, and a pair of bent portions bent at right angles from the base portion and spaced from each other in axial direction of the hinge shaft,
wherein each of the pair of bent portions comprises a shaft hole in which the hinge shaft is disposed, and a raised stopper part projecting from the inner-side surface of the bent portion, for stopping the moving bracket at the full open position of the door when the raised stopper part hits a stopped part of the moving bracket,
wherein, when the moving bracket is in a fully open position, the raised stopper part is extended linearly from an end face of the bent portion that faces the mounting surface of the door toward the stopped part of the moving bracket, and the extend end of the raised stopper part provides a stopper surface where the stopped part is abutted.

2. A method of manufacturing a vehicle door hinge:
wherein the vehicle door hinge comprises,
a moving bracket fixed to a mounting surface of a door;
a fixed bracket fixed to a mounting surface of a vehicle body; and
a hinge shaft pivotably linking the moving bracket and the fixed bracket,
wherein the fixed bracket comprises a base portion fixed to the mounting surface of the vehicle body with a bolt, and a pair of bent portions bent at right angles from the base portion and spaced from each other in axial direction of the hinge shaft,
wherein each of the pair of bent portions comprises a shaft hole in which the hinge shaft is inserted, and a raised stopper part projecting from the inner-side surface of the bent portion, for stopping the moving bracket at the full open position of the door when the raised stopper part hits a stopped part of the moving bracket,
wherein a process for manufacturing the fixed bracket by processing a metal plate material comprises steps of,
a first step for bending the bent portion at right-angles to the base portion by press molding,
a second step for making the shaft hole to the bent portion which is bent, and
a third step for projecting and forming the raised stopper part to the bent portion which is bent.
